(19) United States
(12) Patent Application Publication
(10) Pub. No.: US 2018/0025620 A1
(43) Pub. Date: Jan. 25, 2018

(54) PREDICTIVE MOTION ALERTS FOR SECURITY DEVICES

(71) Applicant: Lenovo (Singapore) Pte. Ltd., Singapore (SG)

(72) Inventors: Arnold S. Weksler, Raleigh, NC (US); John Carl Mese, Cary, NC (US); Russell Speight VanBlon, Raleigh, NC (US); Nathan J. Peterson, Oxford, NC (US)

(21) Appl. No.: 15/217,630

(22) Filed: Jul. 22, 2016

(51) Int. Cl. G08B 29/18; G08B 13/02

(52) U.S. Cl. CPC G08B 29/185; G08B 13/02

(57) ABSTRACT

One embodiment provides a method, including: receiving, at a security device, external data; and adjusting, at the security device, a motion detection feature based on the external data. Other aspects are described and claimed.

### BACKGROUND

Security devices, such as security cameras, infrared motion detectors, etc., can be configured to detect motion. For example, a security camera or other device may activate in response to detection of motion, e.g., trigger an alert or an alarm, begin recording video data, etc. False motion detection, e.g., detection of a tree branch that moves in the wind, detection of traffic on a street, or the like, is often encountered and must be dealt with in order to preserve the usefulness of motion detection.

Infrared detectors are used to mitigate false motion detection; however, objects like moving tree limbs will still result in false motion detection. Many optical sensors allow the user to adjust the sensitivity of the motion detection based on distance or allow a user to eliminate certain zones in the field of view. This amounts to statically reducing the area covered by the optical sensor. Moreover, even if adding an infrared sensor to an optical sensor is performed, and some improvement in false motion detection is achieved, this results in a costlier security system.

### BRIEF SUMMARY

In summary, one aspect provides a method, comprising: receiving, at a security device, external data; and adjusting, at the security device, a motion detection feature based on the external data.

Another aspect provides an electronic device, comprising: a processor; and a memory device that stores instructions executable by the processor to: receive external data; and adjust a motion detection feature based on the external data.

A further aspect provides a product, comprising: a storage device that stores code, the code being executable by a processor and comprising: code that receives external data; and code that adjusts a motion detection feature based on the external data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting a motion detection feature of a security device.

FIG. 4 illustrates an example method of providing predictive motion alerts for security devices.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In order to mitigate false motion detection in security devices, an embodiment gathers external data, e.g., current weather conditions such as wind speed, whether it is raining or snowing, whether there is bright sunlight that causes harsh shadows, etc., and uses the external data to automatically adjust motion detection sensitivity for a security device, e.g., an optical system. For example, if the wind speed is greater than a determined speed (e.g., 10 mph), then the sensitivity of the motion detection can be compensated to reduce false alarms like moving tree limbs. As another example, if the sun is bright, compensation in the motion detection algorithm with respect to detecting the shadows caused by moving objects can be implemented to filter out such data in an effort to eliminate false alarms. As a further example, if external condition data indicates that it is raining or snowing, movement from the top down (vertical object movement in an optical field) can be de-sensitized without impacting lateral movement sensitivity (lateral object movement in an optical field). Therefore, small objects falling slowly downward in the optical field, although detected, are ignored, whereas objects moving horizontally or quickly are detected and cause an alarm. The sensitivity filters can be implemented globally or only within certain regions or zones, e.g., within a particular area of the optical field of the security device.

An embodiment includes configuring a security device to ignore certain constant or repetitive movement. For example, a tree limb movement caused by the wind tends to oscillate in a uniform or consistent motion pattern. A motion detection algorithm can be configured to ignore such repetitive motion and only trigger an alarm when there is a perceived different movement.

In an embodiment recommendations are also provided based on false positive occurrences. Thus, the user might reject motion sensing in a particular context and based on the feedback the security device will adjust the sensitivity of motion detection and/or make a recommendation regarding how such false motion detection may be avoided in the future.

The illustrated example embodiments will be best understood by reference to the figures. The following description is intended only by way of example, and simply illustrates certain example embodiments.

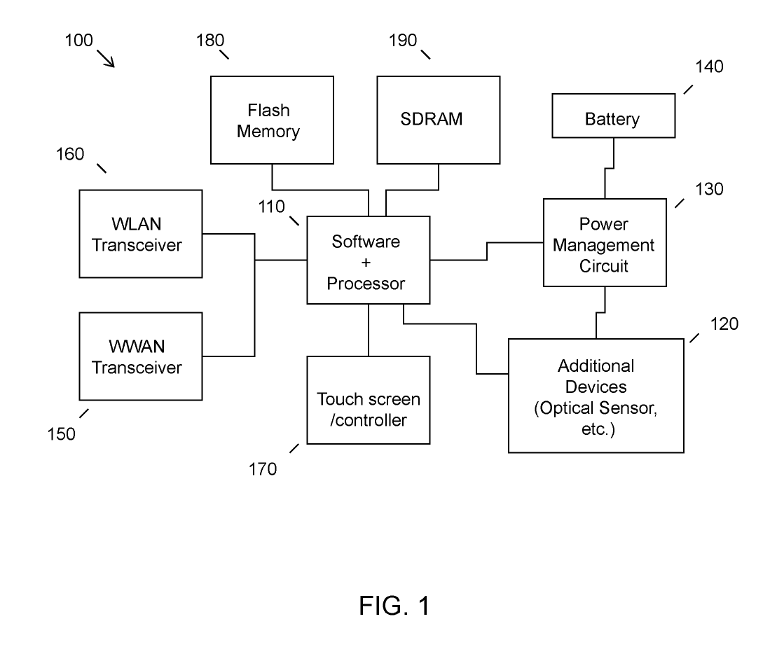

While various other circuits, circuitry or components may be utilized in information handling devices, with regard to some device circuitry 100, an example illustrated in FIG. 1 includes a system on a chip design found for example in many smaller or mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an optical sensor such as a camera and/or an infrared sensor, etc. System 100 often includes a touch screen 170 for data input and display/rendering. System 100 also typically includes various memory devices, for example flash memory 180 and SDRAM 190.

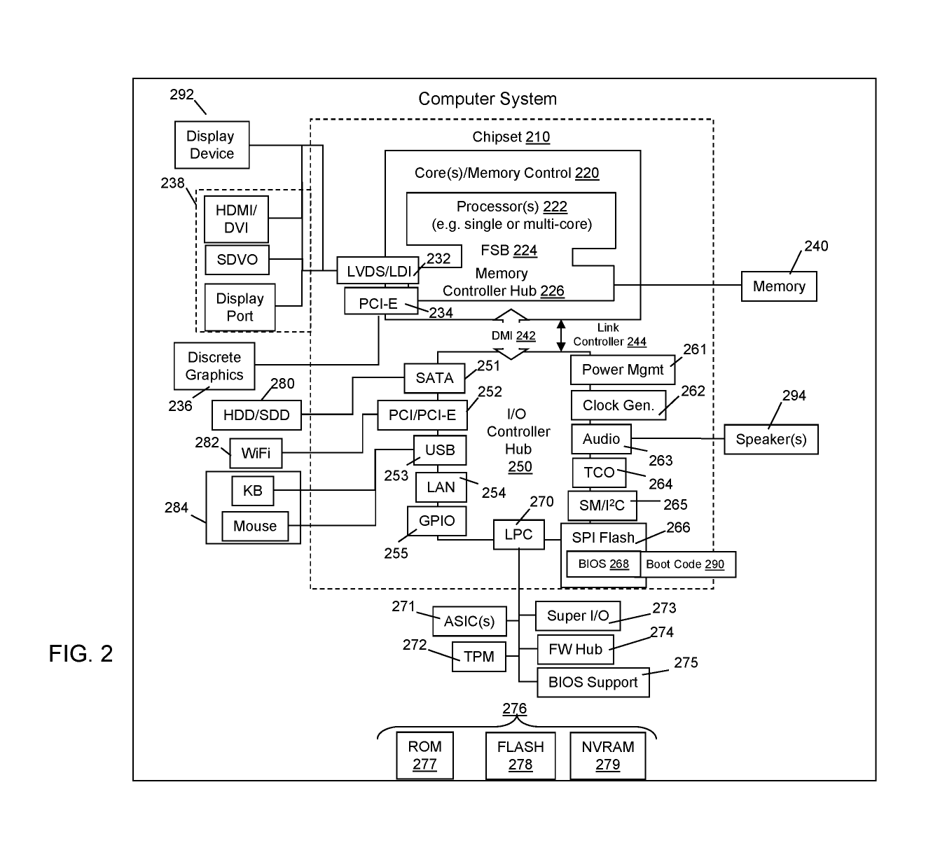

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, biometric data capture device, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in security devices that detect motion using an optical sensor such as a camera. The example circuitry outlined in FIG. 1 or FIG. 2 may also be included in a system device to which a security device connects. For example, a security device may report data, e.g., image data, which is used by another device to detect or confirm detection of object motion. Moreover, a security device may operatively connect to another device, e.g., a remote server, which reports external condition data to the security device and/or provides motion detection algorithms and/or provides adjustments to on-board motion detection algorithms stored on an executed by a security device.

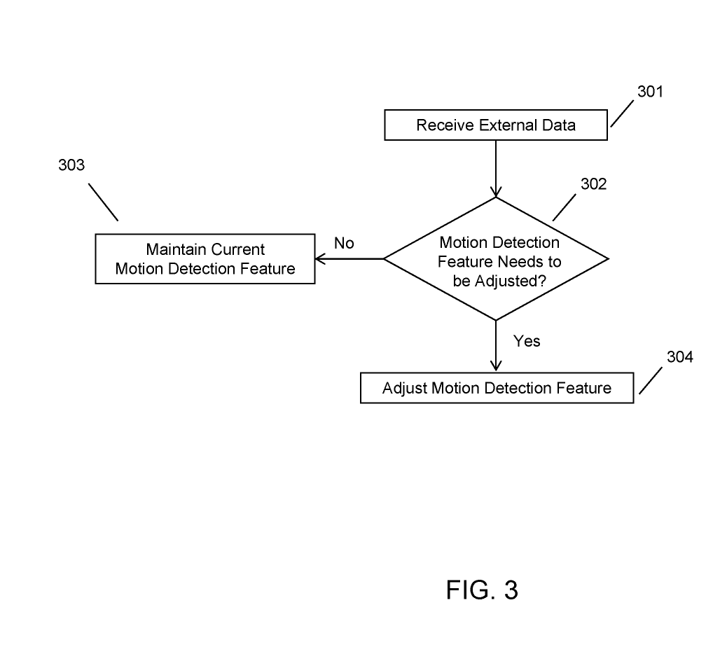

Referring to FIG. 3, an embodiment adjusts a motion detection feature of a security device using external condition data, e.g., weather data or predicted repetitive motion data. By way of example, a security device receives external data, e.g., external condition data such as weather data, at 301. The external data may include current external condition data, e.g., current weather data and/or predetermined external data, e.g., a predetermined motion filter, predetermined external condition data (e.g., for a specific geographic region, street location, etc.). This external data permits the adjustment of a motion detection feature of the security device, if necessary. For example, a security device may determine if a current motion detection algorithm or setting of a current motion algorithm is appropriate given the external data. By way of specific example, at 302 an embodiment may determine that a currently loaded motion detection algorithm at the security device is not optimized for rain or windy conditions. As such, an embodiment may adjust the motion detection feature of the security device at 304, e.g., loading an entirely new motion detection algorithm, changing part of a currently loaded motion detection algorithm, or adding onto a currently loaded motion detection algorithm. If the external data indicates that the motion detection feature is acceptable, then the current motion detection feature may be maintained, as illustrated at 303.

The motion detection feature may be adjusted at 304 in a variety of ways. By way of example, a security device may adjust a motion detection feature at 304 by loading a new motion detection algorithm that is optimized for windy conditions based on received external data, e.g., external condition data including weather data indicating that high winds are expected.

As another example, a security device may retain the current motion detection algorithm, but be instructed to adjust the motion detection feature at 304 by transmitting any motion detection data that typically would trigger an alarm to another, remote device for further processing, e.g., using another motion detection algorithm that is optimized to detect repetitive movement, e.g., of tree branches the blow in the wind, and to filter out the same. Thus, another device may be used to confirm the motion detection of the security device. A similar confirmation functionality may be provided to the security device, e.g., as an update in response to external condition data.

As a further example, a security device may have an on-board motion detection algorithm itself adjusted at 304, e.g., by updating the algorithm with logic to filter out repetitive motion in response to external condition data that indicates high winds are expected.

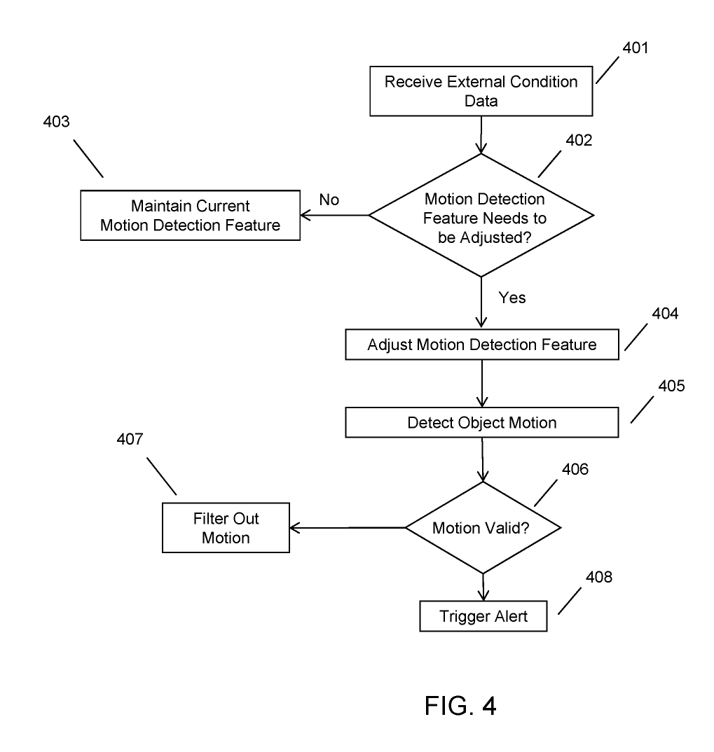

As shown in FIG. 4, a security device receives external condition data, e.g., weather data, at 401. This external condition data permits the adjustment of a motion detection feature of the security device, if necessary. For example, a security device may determine if a current motion detection algorithm or setting of a current motion algorithm is appropriate given the external condition data. By way of specific example, at 402 an embodiment may determine that a currently loaded motion detection algorithm at the security device is not optimized for detecting and filtering of repeated horizontal motions, e.g., rain or snow that repeatedly traverses the optical field in a vertical direction from top to bottom.

An embodiment may adjust the motion detection feature of the security device at 404, e.g., loading an entirely new motion detection algorithm, changing part of a currently loaded motion detection algorithm, or adding onto a currently loaded motion detection algorithm. If the external data indicates that the motion detection feature is acceptable, then the current motion detection feature may be maintained, as illustrated at 403.

Having adjusted the motion detection feature, the security device may thereafter detect object motion, as illustrated at 405. The security device may employ the adjusted motion detection feature, e.g., motion detection algorithm that has been optimized based on current external conditions such as weather, repetitive motion, etc., to determine if the motion is valid, as illustrated at 406. If the motion is valid, as determined at 406, the security device may trigger an alert or alarm, as illustrated at 408; otherwise, the security device may filter out the motion, i.e., not trigger an alert or alarm, as illustrated at 407.

As described herein, the updating or adjustment of the motion detection feature, e.g., as illustrated at 403 and/or 404, may be based at least in part on a learning algorithm. For example, positive or negative feedback, for example provided by user input, may be used to change the adjustment that is made at 404 and/or the determination that a motion detection feature needs to be adjusted, as illustrated at 403. This helps to improve the security device or system in terms of accuracy, particularly from the stand point of the user's view of system performance.

An embodiment therefore uses external condition data to determine if the motion that is detected or detectable should in fact trigger an alarm. In an embodiment, this is accomplished by tuning or adjusting a motion detection feature of the security device, either on board or as assisted using a remote device. The external condition data helps to inform the security device or system of current or predicted external conditions that may trigger false motion detection. The external condition data may be retrieved or updated based on a policy, e.g., once per day, once per hour, once per minute, etc., such that the security device or system has a capability of adjusting the motion detection feature to suit particular external conditions that are known to trigger false positive motion detections.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at a security device, external data; and
adjusting, at the security device, a motion detection feature based on the external data.

2. The method of claim 1, further comprising:
detecting, at the security device, motion of an object; and
determining, at the security device, that the motion of the object should be filtered out based on the external condition data.

3. The method of claim 1, wherein the external data is external condition data.

4. The method of claim 3, wherein the external condition data is current condition data.

5. The method of claim 4, wherein the current condition data is weather data.

6. The method of claim 3, wherein the external condition data is updated according to a policy.

7. The method of claim 1, wherein the external data is a predetermined object motion filter.

8. The method of claim 7, wherein the predetermined object motion filter comprises a predetermined pattern filter for vertical object movement.

9. The method of claim 7, wherein the predetermined object motion filter is a repetitive motion filter.

10. The method of claim 9, wherein the predetermined object motion filter is applied to an area in the field of view of the security device.

11. An electronic device, comprising:
a processor; and
a memory device that stores instructions executable by the processor to:
receive external data; and
adjust a motion detection feature based on the external data.

12. The electronic device of claim 11, wherein the instructions are executable by the processor to:
detect motion of an object; and
determine that the motion of the object should be filtered out based on the external condition data.

13. The electronic device of claim 11, wherein the external data is external condition data.

14. The electronic device of claim 13, wherein the external condition data is current condition data.

15. The electronic device of claim 14, wherein the current condition data is weather data.

16. The electronic device of claim 13, wherein the external condition data is updated according to a policy.

17. The electronic device of claim 11, wherein the external data is a predetermined object motion filter.

18. The electronic device of claim 17, wherein the predetermined object motion filter comprises a predetermined pattern filter for vertical object movement.

19. The electronic device of claim 17, wherein the predetermined object motion filter is a repetitive motion filter.

20. A product, comprising:
a storage device that stores code, the code being executable by a processor and comprising:
code that receives external data; and
code that adjusts a motion detection feature based on the external data.
